(19) United States
(12) Patent Application Publication
(10) Pub. No.: US 2021/0117783 A1
(43) Pub. Date: Apr. 22, 2021

(54) DISTRIBUTED PROCESSING SYSTEM AND DISTRIBUTED PROCESSING METHOD

(71) Applicant: NIPPON TELEGRAPH AND TELEPHONE CORPORATION, Tokyo (JP)

(72) Inventors: Kenji KAWAI, Tokyo (JP); Junichi KATO, Tokyo (JP); Huycu NGO, Tokyo (JP); Yuki ARIKAWA, Tokyo (JP); Tsuyoshi ITO, Tokyo (JP); Takeshi SAKAMOTO, Tokyo (JP)

(73) Assignee: Nippon Telegraph and Telephone Corporation, Tokyo (JP)

(21) Appl. No.: 16/967,463

(22) PCT Filed: Feb. 6, 2019
(86) PCT No.: PCT/JP2019/004214

§ 371 Date: Aug. 5, 2020

(30) Foreign Application Priority Data
Feb. 16, 2018 (JP) 2018-025942

(51) Int. Cl. G06N 3/08; G06N 3/04; H04L 7/00

(52) U.S. Cl. CPC G06N 3/08; H04L 7/0091; H04L 7/0079; G06N 3/04

(57) ABSTRACT

Each of distributed processing nodes [n] (n=1, . . . , and N) packetizes pieces of distributed data [m, n] as packets for every M weights w [m] ((m=1, . . . , and M) of a neural network to be learned in an order of numbers m, transmits the packets to a consolidation processing node, receives a packet transmitted from the consolidation processing node to acquire consolidated data R [m] in the order of numbers m and update the weights w [m] of the neural network on the basis of the consolidated data R [m].

### CROSS-REFERENCE TO RELATED APPLICATIONS

This application is a national phase entry of PCT Application No. PCT/JP2019/004214, filed on Feb. 6, 2019, which claims priority to Japanese Patent Application No. 2018-025942 filed on Feb. 16, 2018, which application are hereby incorporated herein by reference.

### TECHNICAL FIELD

The present invention relates to a distributed processing system and a distributed processing method for performing learning of a neural network by associating a consolidation processing node and a plurality of distributed processing nodes with each other.

### BACKGROUND

In deep learning, the accuracy of inference is improved by updating a weight of each neuron model (a coefficient multiplied by a value output by a neuron model at a previous stage) on the basis of input sample data for a learning target constituted by a multi-layered neuron model.

A mini batch method is typically used for a method of improving the accuracy of inference. In a mini batch method, a gradient calculation process of calculating a gradient with respect to the weight for each piece of sample data, a consolidation process of consolidating the gradient for a plurality of different pieces of sample data (summing up the gradients, obtained for each piece of sample data, for each weight), and a weight updating process of updating each weight on the basis of the consolidated gradient are repeated.

These processes, particularly the gradient calculation process, require many iterated computations, but there is a problem in that a time required for deep learning increases as the number of weights and the number of pieces of input sample data increase in order to improve the accuracy of inference.

In order to increase the speed of the gradient calculation process, a distributed processing method is used. Specifically, a plurality of distributed processing nodes are provided, and each of the nodes performs a gradient calculation process for each of different pieces of sample data. As a result, as the number of pieces of sample data that can be processed per unit time in proportion to the number of nodes can be increased, the speed of the gradient calculation process can be increased (see NPL 1).

In order to perform a consolidation process in distributed processing of deep learning, communication (aggregation communication) from each of distributed processing nodes to a consolidation processing node for aggregating data (distributed data) obtained for each of the distributed processing nodes into the consolidation processing node, an all-nodes consolidation process in the consolidation processing node, and communication from the consolidation processing node to the distributed processing nodes (dispatch communication) for transmitting data consolidated by the consolidation processing node (consolidated data) to each of the distributed processing nodes are required.

FIG. 12 shows a sequence of distributed processing of deep learning according to the related art. Distributed processing nodes 100 [n] (n=1, . . . , and N) perform the input of sample data, a gradient calculation process, and an in-node consolidation process in a period I, and transmit distributed data to a consolidation processing node 101. In a period II, transmission from such nodes is performed, but the nodes do not necessarily transmit distributed data at the same time.

In a period III, the consolidation processing node 101 performs an all-nodes consolidation process of summing up gradients obtained from the nodes for each weight, and the consolidated data is transmitted to each of the distributed processing nodes 100 [n] in a period IV. In a period V, each of the distributed processing nodes 100 [n] performs a weight updating process.

Thus, processing times of aggregation communication (II), the all-nodes consolidation process (III), and dispatch communication (IV) are added to deep learning by the execution of distributed processing.

Such processing times are unnecessary in a system that performs deep learning in a single node, which results in a reduction in a processing speed in performing distributed processing of deep learning.

In recent years, deep learning has been applied to more complicated problems, and a total number of weights tends to increase. For this reason, as the amount of distributed data and the amount of the consolidated data have increased, an aggregation communication time and a dispatch communication time have increased.

In this manner, a distributed system of deep learning has a problem that the effect of increasing the speed of deep learning is reduced due to, because of an increase in the number of distributed processing nodes, increases in the aggregation communication time and the dispatch communication time. FIG. 13 shows a relationship between the number of distributed processing nodes and processing performance of deep learning in the distributed processing system of the related art, reference numeral 200 denotes an ideal relationship between the number of distributed processing nodes and processing performance (performance proportional to the number of nodes), and reference numeral 201 denotes an actual relationship between the number of distributed processing nodes and processing performance.

### CITATION LIST

### Non Patent Literature

NPL 1: Akiba Takuya, [symbol] [symbol] C h a i n e r M N [symbol] (Distributed deep learning package ChainerMN published),” Preferred Infrastructure, 2017, Internet <https://research.preferred.jp/2017/05/chainermn-beta-release/>

### SUMMARY

### Technical Problem

An object of some aspects of the disclosure is to provide a distributed processing system and a distributed processing method which are capable of improving the learning efficiency of a neural network in the distributed processing system that includes a consolidation processing node and a plurality of distributed processing nodes.

### Means for Solving the Problem

A distributed processing system of embodiments of the present invention includes a consolidation processing node, and N distributed processing nodes (N is an integer equal to or greater than 2), in which each of the distributed processing nodes is configured to packetize distributed data D [m, n] (n=1, . . . , and N) as packets for every M weights w [m] (m=1, . . . , and M)(M is an integer equal to or greater than 2) of a neural network to be learned in an order of numbers m of weights w [m] to transmit the packets to the consolidation processing node, and receive packets transmitted from the consolidation processing node to acquire consolidated data R [m] in the order of numbers m to update the weights w [m] of the neural network on the basis of the consolidated data R [m], and the consolidation processing node is configured to receive the packets transmitted from each of the distributed processing nodes to acquire the distributed data D [m, n] in the order of numbers m, generate the consolidated data R [m] obtained by consolidating the distributed data D [m, n] of all of the distributed processing nodes for each weight w [m], and packetize the consolidated data R [m] as packets in the order of numbers m to transmits the packets to each of the distributed processing nodes.

Further, in one configuration example of the distributed processing system of the present invention, each of the distributed processing nodes includes a transmission unit configured to packetize the distributed data D [m, n] as packets in the order of numbers m to transmit the packets to the consolidation processing node, a reception unit configured to receive the packets transmitted from the consolidation processing node to acquire the consolidated data R [m] in the order of numbers m, and a weight updating processing unit configured to update a weight w [m] of the neural network on the basis of the consolidated data R [m].

Further, in one configuration example of the distributed processing system of the present invention, the consolidation processing node includes a reception unit configured to receive the packets transmitted from each of the distributed processing nodes to acquire the distributed data D [m, n] in the order of numbers m, a consolidation processing unit configured to generate the consolidated data R [m] obtained by consolidating the distributed data D [m, n] of all of the distributed processing nodes for each weight w [m], and a transmission unit configured to packetize the consolidated data R [m] as packets in the order of numbers m to transmit the packets to each of the distributed processing nodes.

Further, in one configuration example of the distributed processing system of the present invention, each of the distributed processing nodes further includes a gradient calculation processing unit configured to calculate a gradient of a loss function of the neural network for each piece of sample data with respect to each of the weights w [m] of the neural network when sample data for learning of the neural network is input, and an in-node consolidation processing unit configured to generate and store the distributed data D [m, n], which is numerical values obtained by consolidating the gradients for each piece of sample data, for each weight w [m].

Further, in one configuration example of the distributed processing system of the present invention, the consolidation processing node and each of the distributed processing nodes perform, in parallel for different numbers m, an aggregation communication process of transmitting, at each of the distributed processing nodes, the distributed data D [m, n] packetized as packets to the consolidation processing node to acquire, at the consolidation processing node, the distributed data D [m, n] from the packets received, an all-nodes consolidation process of generating, at the consolidation processing node. the consolidated data R [m], a dispatch communication process of transmitting, at the consolidation processing node, the consolidated data R [m] packetized as packets to each of the distributed processing nodes to acquire, at each of the distributed processing nodes, the consolidated data R [m] from the packets received, and a weight updating process of updating, at each of the distributed processing nodes, the weight w [m].

Further, a distributed processing method of embodiments of the present invention includes a first procedure of packetizing, at each of N distributed processing nodes (N is an integer equal to or greater than 2), distributed data D [m, n] (n=1, . . . , and N) for every M weights w [m] (m=1, . . . , and M)(M is an integer equal to or greater than 2), as packets, of a neural network to be learned in an order of numbers m of weights w [m] to transmit the packets to the consolidation processing node, a second procedure of receiving, at the consolidation processing node, the packets transmitted from each of the distributed processing nodes to acquire the distributed data D [m, n] in the order of numbers m, a third procedure of generating, at the consolidation processing node, consolidated data R [m] obtained by consolidating the distributed data D [m, n] of all of the distributed processing nodes for each weight w [m], a fourth procedure of packetizing, at the consolidation processing node, the consolidated data R [m] as packets in the order of numbers m to transmit the packets to the distributed processing nodes, a fifth procedure of receiving, at each of the distributed processing nodes. the packets transmitted from the consolidation processing node, to acquire the consolidated data R [m] in the order of numbers m, and a sixth procedure of causing each of the distributed processing nodes to update a weight w [m] of the neural network on the basis of the consolidated data R [m].

Further, one configuration example of the distributed processing method of the present invention further includes a seventh procedure of calculation, before the first procedure, at each of the distributed processing nodes, a gradient of a loss function of the neural network for each piece of sample data with respect to each of the weights w [m] of the neural network when sample data for learning of the neural network is input, and an eighth procedure of generating and storing, at each of the distributed processing nodes. the distributed data D [m, n], which is numerical values obtained by consolidating the gradients for each piece of sample data, for each weight w [m].

Further, in one configuration example of the distributed processing method of the present invention, the first procedure at the distributed processing nodes and the second procedure at the consolidation processing node, the third procedure at the consolidation processing node, the fourth procedure at the consolidation processing node and the fifth procedure at the distributed processing nodes, and the sixth procedure at the distributed processing nodes are performed in parallel for different numbers m.

### Effects of Embodiments of the Invention

According to embodiments of the present invention, it is possible to simultaneously perform a process of transmitting distributed data from each of distributed processing node to a consolidation processing node, and a process of transmitting consolidated data from the consolidation processing node to each of the distributed processing nodes, by; at each of the distributed processing node, packetizing distributed data for each weight of a neural network to transmit the packetized distributed data to the consolidation processing node in an order and acquiring the consolidated data stored in packets transmitted from the consolidation processing node in the order to update the weights of the neural network, and, at the consolidation processing node, acquiring distributed data stored in the packetized distributed data transmitted from the distributed processing nodes in the order and packetize consolidated data obtained by consolidating distributed data of all of the distributed processing nodes so as to transmit the packetized data to each of the distributed processing nodes, to perform effective distributed processing, and to improve the learning efficiency of the neural network.

### BRIEF DESCRIPTION OF THE DRAWINGS

FIG. 1 is a block diagram showing a configuration example of a distributed processing system for deep learning according to a first example of the present invention.

FIG. 2 is a block diagram showing a configuration example of a distributed processing node of the distributed processing system for deep learning according to the first example of the present invention.

FIG. 3 is a flowchart showing a sample data input process, a gradient calculation process, and an in-node consolidation process of the distributed processing node according to the first example of the present invention.

FIG. 4 is a flowchart showing an aggregation communication process of the distributed processing node according to the first example of the present invention.

FIG. 5 is a flowchart showing an aggregation communication process of a consolidation processing node according to the first example of the present invention.

FIG. 6 is a flowchart showing an all-nodes consolidation process of a consolidation processing node according to the first example of the present invention.

FIG. 7 is a flowchart showing a dispatch communication process of the consolidation processing node according to the first example of the present invention.

FIG. 8 is a flowchart showing a dispatch communication process of the distributed processing node according to the first example of the present invention.

FIG. 9 is a flowchart showing a weight updating process of the distributed processing node according to the first example of the present invention.

FIG. 10 is a diagram showing a sequence of processing of the consolidation processing node and the distributed processing node according to the first example of the present invention.

FIG. 11 is a block diagram showing a configuration example of a consolidation processing node according to a second example of the present invention.

FIG. 12 is a diagram showing a sequence of distributed processing of deep learning of the related art.

FIG. 13 is a diagram showing a relationship between the number of distributed processing nodes and processing performance of deep learning in a distributed processing system of the related art.

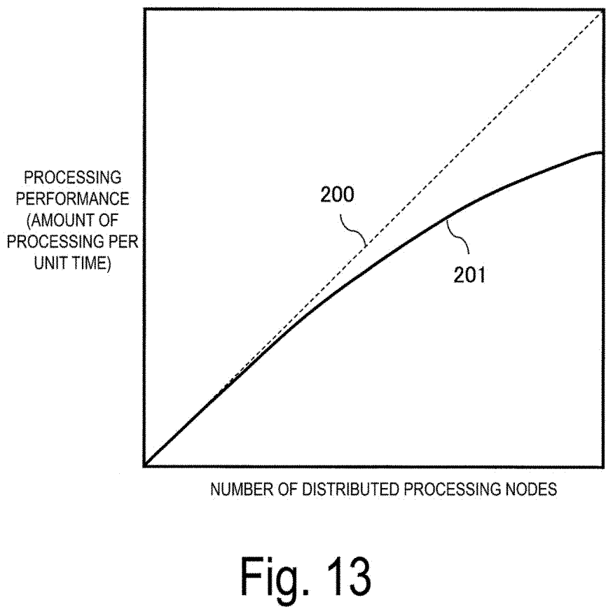

### DETAILED DESCRIPTION OF ILLUSTRATIVE EMBODIMENTS

### First Example

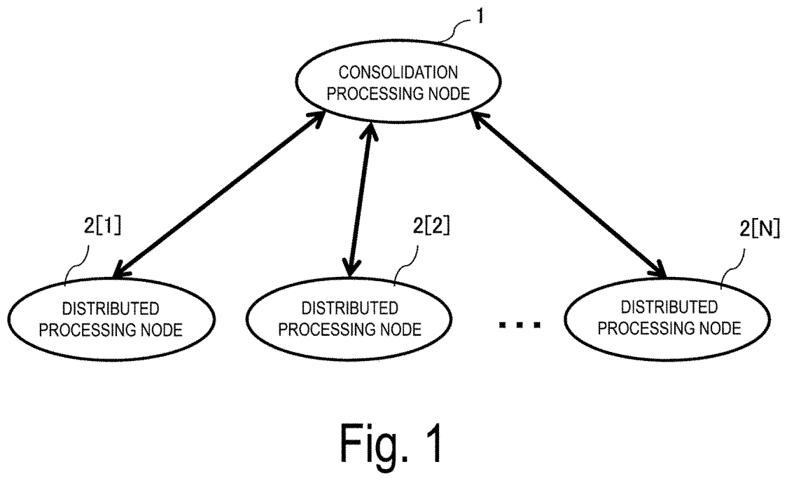

Examples of the present invention will be described below with reference to the drawings. FIG. 1 is a block diagram showing a configuration example of a distributed processing system for deep learning according to a first example of the present invention. The distributed processing system in FIG. 1 includes one consolidation processing node 1 and N distributed processing nodes 2[n] (n=1, . . . , and N) provided for each set of sample data (learning data) of a neural network (N is an integer equal to or greater than 2). Each of the distributed processing nodes 2[n] is connected to the consolidation processing node 1 through a network 3 capable of bi-directional communication.

Note that, in embodiments of the present invention, “nodes” refers to devices such as servers dispersedly disposed on a network.

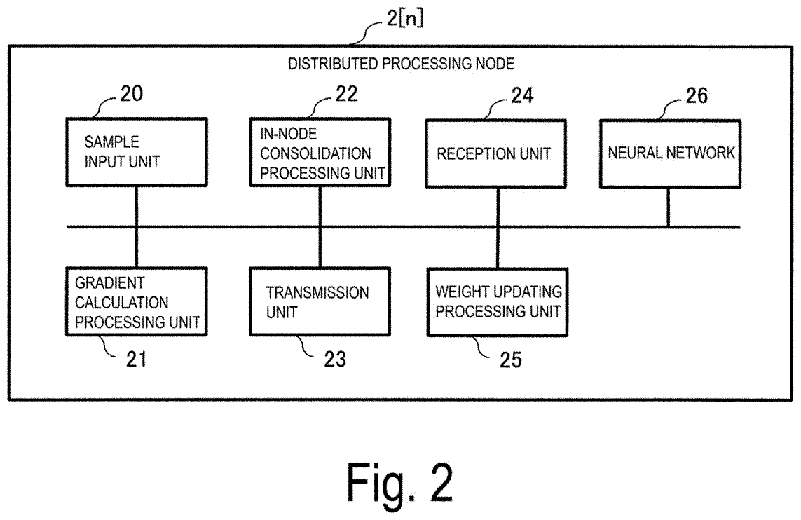

FIG. 2 is a block diagram showing a configuration example of the distributed processing nodes 2[n]. Each of the distributed processing nodes 2[n] includes a sample input unit 20, a gradient calculation processing unit 21, an in-node consolidation processing unit 22, a transmission unit 23, a reception unit 24, a weight updating processing unit 25, and a neural network 26. The sample input unit 20 receives sample data for learning from a data collecting node (not shown). The gradient calculation processing unit 21 calculates a gradient of a loss function of a neural network for each piece of sample data with respect to each of weights of the neural network when the sample data is input. The in-node consolidation processing unit 22 generates and stores distributed data, which is numerical values obtained by consolidating gradients for each piece of sample data, with respect to each weight. The transmission unit 23 packetizes distributed data as packets and transmits the packets to the consolidation processing node 1. The reception unit 24 receives the packets transmitted from the consolidation processing node 1 to acquire consolidated data. The weight updating processing unit 25 updates a weight of the neural network on the basis of the consolidated data. The neural network 26 is a mathematical model constructed as software.

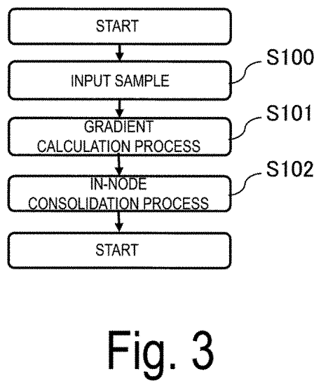

FIG. 3 is a flowchart showing a sample data input process, a gradient calculation process, and an in-node consolidation process of the distributed processing node 2[n]. The sample input unit 20 of each of the distributed processing nodes 2[n] (n=1, . . . , and N) inputs different S pieces of sample data x[n, s] (s=1, . . . , and s) for each mini batch from a data collecting node not shown in the drawing (S is an integer equal to or greater than 2) (step S1oo in FIG. 3).

Note that the present invention is not limited to a sample data collecting method performed by a data collecting node and a method of dividing collected sample data into N sets and dispatching each of the sets to each of distributed processing nodes 2[n], and any method can be applied.

When sample data x[n, s] is input, the gradient calculation processing unit 21 of each of the distributed processing nodes 2[n] (n=1, . . . , and N) calculates a gradient G[m, n, s] of a loss function of the neural network 26 for each piece of sample data x[n, s] with respect to each of M weights w [m] (m=1, . . . , and M) of the neural network 26 to be learned (M is an integer equal to or greater than 2) (step S101 in FIG. 3).

A method of constructing the neural network 26 in each of the distributed processing nodes 2[n] as software, a weight w [m] of the neural network 26, a loss function, which is an indicator indicating of the degree of poorness of performance of the neural network 26, and a gradient G[m, n, s] of the loss function are well-known techniques, and thus detailed description thereof will be omitted.

Next, the in-node consolidation processing unit 22 of each of the distributed processing nodes 2[n] (n=1, . . . , and N) generates and stores distributed data D [m, n], which is numerical values obtained by consolidating a gradient G[m, n, s] for each piece of sample data, for each weight w [m] (step S102 in FIG. 3). A calculation equation for the distributed data D [m, n] is as follows.

[Equation1]

D[m,n]=Σ_{s=1, . . . ,s}G[m,n,s] (1)

Note that a gradient calculation process performed by the gradient calculation processing unit 21 and an in-node consolidation process performed by the in-node consolidation processing unit 22 can be performed in a pipelined manner in units of sample data (the gradient calculation process for any sample data and the in-node consolidation process of consolidating a gradient obtained from one sample data prior to the sample data can be performed at the same time).

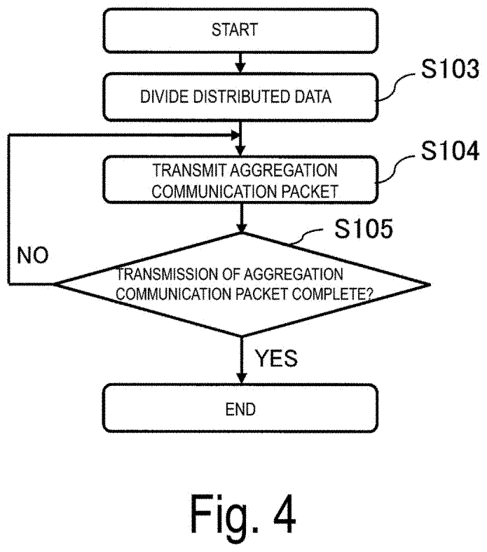

FIG. 4 is a flowchart showing an aggregation communication process of the distributed processing node 2[n]. The transmission unit 23 of each of the distributed processing nodes 2[n] (n=1, . . . , and N) performs aggregation communication for packetizing distributed data D [m, n] (m=1, . . . , and M) as packets for each weight w [m] in an order of numbers m of weights w [m] and transmitting the packets to the consolidation processing node 1.

In this case, the transmission unit 23 of each of the distributed processing nodes 2[n](n=1, . . . , and N) divides M stored pieces of distributed data D [m, n] (m=1, . . . , and M) into Pg aggregation communication packets (Pg is an integer equal to or greater than 2) by Lg (Lg is an integer equal to or greater than 1 and less than M) (step S103 in FIG. 4) and transmit Pg aggregation communication packets to the consolidation processing node 1 in order (step S104 in FIG. 4) until all of the aggregation communication packets have been transmitted (YES in step S105 in FIG. 4). In other words, Lg pieces of distributed data D[i, n] (i=Lg×(p−1)+l, l=1, . . . , and Lg) are stored in the p-th aggregation communication packet SP [p, n] to be transmitted (p=1, . . . , and Pg).

Note that (M−Lg×(Pg−1)) pieces of distributed data D[i, n] (I=Lg×(Pg−1)+q, q=1, . . . , and M−Lg×(Pg−1)) are stored in the Pg-th aggregation communication packet SP[Pg, n] in a condition where M cannot be divided by Lg.

Numerical values of {Lg−(M−Lg×(Pg−1))} dummies may be added after (M−Lg×(Pg−1)) pieces of distributed data D[i, n] for the Pg-th aggregation communication packet SP[Pg, n], and all of the aggregation communication packets may equally store Lg pieces of data.

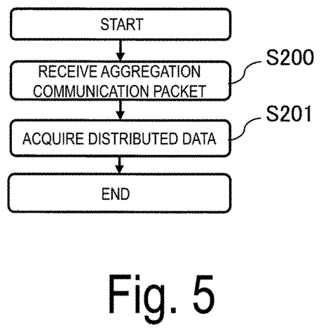

FIG. 5 is a flowchart showing an aggregation communication process of the consolidation processing node 1. In aggregation communication, the consolidation processing node 1 receives aggregation communication packets SP[p, n] (p=1, . . . , and Pg) transmitted by each of the distributed processing nodes 2[n] (step S200 in FIG. 5).

The consolidation processing node 1 acquires Lg pieces of distributed data D[i, n] (i=Lg×(p−1)+l, l=1, . . . , and Lg) stored by the distributed processing node 2[n] from the received aggregation communication packet SP[p, n] (step S201 in FIG. 5).

In this manner, the consolidation processing node 1 can acquire the distributed dataD [m, n] (m=, . . . , and M) stored by each of the distributed processing nodes 2[n] (n=1, . . . , and N) in the order of numbers m of weights w [m].

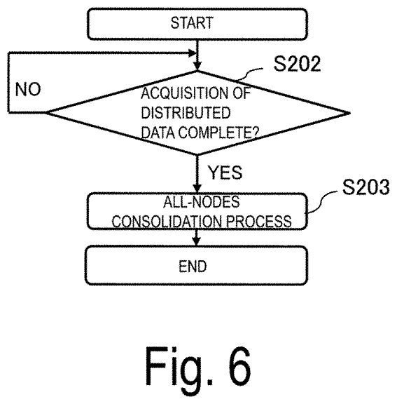

FIG. 6 is a flowchart showing an all-nodes consolidation process of the consolidation processing node 1. The consolidation processing node 1 acquires distributed data D [m, n] of a weight w [m] from each of the distributed processing nodes 2[n] (n=1, . . . , and N) (YES in step S202 in FIG. 6) and then performs an all-nodes consolidation process of consolidating the acquired distributed data D [m, n] of all of the distributed processing nodes 2[n] for each weight w [m] to generate consolidated data R [m] (step S203 in FIG. 6). A calculation equation for the consolidated data R [m] is as follows.

[Equation2]

R[m]=Σ_{n=1, . . . ,N}D m,n] (2)

In this manner, a consolidation process is a process of calculating consolidated data R [m] on the basis of distributed data D [m, n] acquired in an order of numbers m. Thus, the consolidation processing node 1 can generate the consolidated data R [m] in the order of the numbers m.

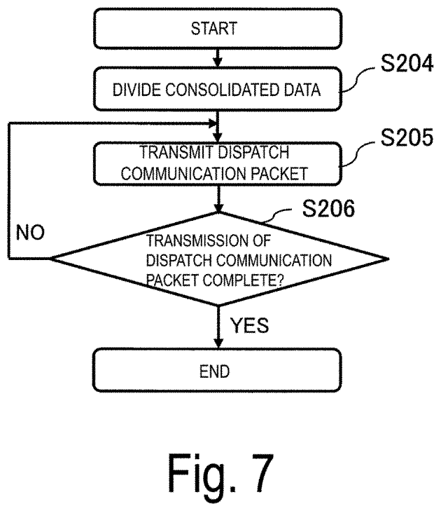

FIG. 7 is a flowchart showing a dispatch communication process of the consolidation processing node 1. The consolidation processing node 1 performs dispatch communication for packetizing consolidated data R [m] (m=1, . . . , and M) as packets for each weight w [m] in the order of numbers m of weights w [m] and transmitting the packets to each of the distributed processing nodes 2[n] (n=1, . . . , and N).

In this case, the consolidation processing node 1 divides M pieces of consolidated data R [m] (m=1, . . . , and M) into Ps dispatch communication packets (Ps is an integer equal to or greater than 2) by Ls pieces of the consolidated data (Ls is an integer equal to or greater than 1 and less than M) (step S204 in FIG. 7) and transmits the Ps dispatch communication packets to each of the distributed processing nodes 2[n] (n=1, . . . , and N) in order (step S205 in FIG. 7) until all of the dispatch communication packets are transmitted (YES in step S206 in FIG. 7). That is, Ls pieces of consolidated data R [j](=Ls×(p−1)+k, k=1, . . . , and Ls) are stored in the p-th dispatch communication packet DP[p, n] (p=1, . . . , and Ps) which is transmitted toward the distributed processing node 2 [n].

Note that (M−Ls×(Ps−1)) pieces of consolidated data R[j] (j=Ls×(Ps−1)+0; 0=1, . . . , and M−Ls×(Ps−1)) are stored in the Ps-th dispatch communication packet DP [Ps, n] in a condition where M cannot be divided by Ls.

Numerical values of {Ls−(M−Ls×(Ps−1))} dummies may be added after (M−Ls×(Ps−1)) pieces of consolidated data R[j] for the Ps-th dispatch communication packet DP[Ps, n], and all of the dispatch communication packets may equally store Ls pieces of data.

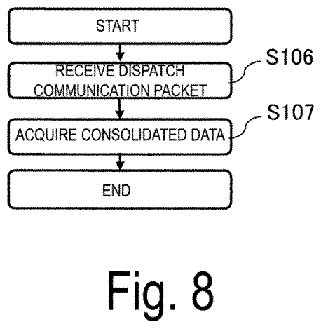

FIG. 8 is a flowchart showing a dispatch communication process of the distributed processing node 2[n]. In dispatch communication, the reception unit 24 of each of the distributed processing nodes 2[n] (n=1, . . . , and N) receives dispatch communication packets DP[p, n] (p=1, . . . , and Ps) transmitted by the consolidation processing node 1 in order (step S106 in FIG. 8).

Then, the reception unit 24 of each of the distributed processing nodes 2[n] (n=1, . . . , and N) acquire Ls pieces of consolidated data R[j] (j=Ls×(p−1)+k, k=1, . . . , and Ls) generated by the consolidation processing node 1 from the received dispatch communication packets DP[p, n] (step S107 in FIG. 8).

In this manner, each of the distributed processing nodes 2[n] (n=1, . . . , and N) can acquire consolidated data R [m] (m=1, . . . , and M) generated by the consolidation processing node 1 in the order of numbers m of weights w [m].

Note that the same consolidated data R[j] (j=Ls×(p−1)+k, k=1, . . . , and Ls) regarding all of the distributed processing nodes 2[n] is stored in the p-th dispatch communication packet DP[p, n] which is transmitted by the consolidation processing node 1. Thus, in a case where it is not necessary to designate a destination for the dispatch communication packet DP[p, n] (for example, in a case where a path is different for each distributed processing node as shown in FIG. 1, or in a case where a network for performing multicasting to all of the distributed processing nodes is interposed), the same dispatch communication packet DP[p] may be transmitted to all of the distributed processing nodes 2[n].

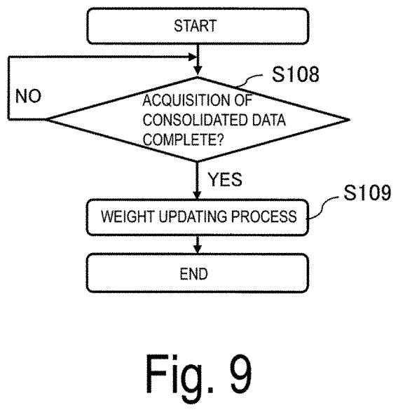

FIG. 9 is a flowchart showing a weight updating process of the distributed processing node 2 [n]. The weight updating processing unit 25 of each of the distributed processing nodes 2 [n] (n=1, . . . , and N) performs a weight updating process of acquiring consolidated data R [m] of a weight w [m] from the consolidation processing node 1 (YES in step S108 in FIG. 9) and then updating weights w [m] of the neural networks 26 in the respective nodes on the basis of the pieces of acquired consolidated data R [m] (step S109 in FIG. 9).

In the weight updating process, a weight w [m] may be updated for each number m so that a loss function is minimized on the basis of a gradient of the loss function which is indicated by consolidated data R [m]. The updating of a weight w [m] is a well-known technique, and thus detailed description thereof will be omitted.

In this manner, the weight updating process is a process of updating a weight w [m] on the basis of the pieces of consolidated data R [m] acquired in the order of numbers m of weights w [m]. For this reason, each of the distributed processing nodes 2 [n] (n=1, . . . , and N) can perform a weight updating process for a weight w [m] in the order of numbers m.

One mini batch learning is terminated due to the termination of the weight updating process, and each of the distributed processing nodes 2 [n] (n=1, . . . , and N) and the consolidation processing node 1 continuously perform the next mini batch learning process on the basis of the updated weights. That is, each of the distributed processing nodes 2 [n] receives sample data for the next mini batch learning from a data collecting node which is not shown in the drawing, and repeat the above-described mini batch learning process to improve the accuracy of inference of the neural network 26.

Note that the termination of repetition of the mini batch learning includes (A) a case where the number of times of mini batch learning reaches a value designated in advance, (B) a case where the accuracy of inference of the neural network 26 (for example, a percentage of correct answers when the neural network 26 infers a known problem) exceeds a threshold value designated in advance, (C) a case where an improvement in the accuracy of inference of the neural network 26 is stopped (in a case where an increase in the accuracy of inference falls below a threshold value designated in advance when the number of times of mini batch learning designated in advance is repeated), or (D) a case where a combination of at least two cases of (A) to (C) occurs. The termination of such repetition of mini batch learning may be determined individually by each of the distributed processing nodes 2 [n] (n=1, . . . , and N), or may be determined comprehensively by the consolidation processing node 1.

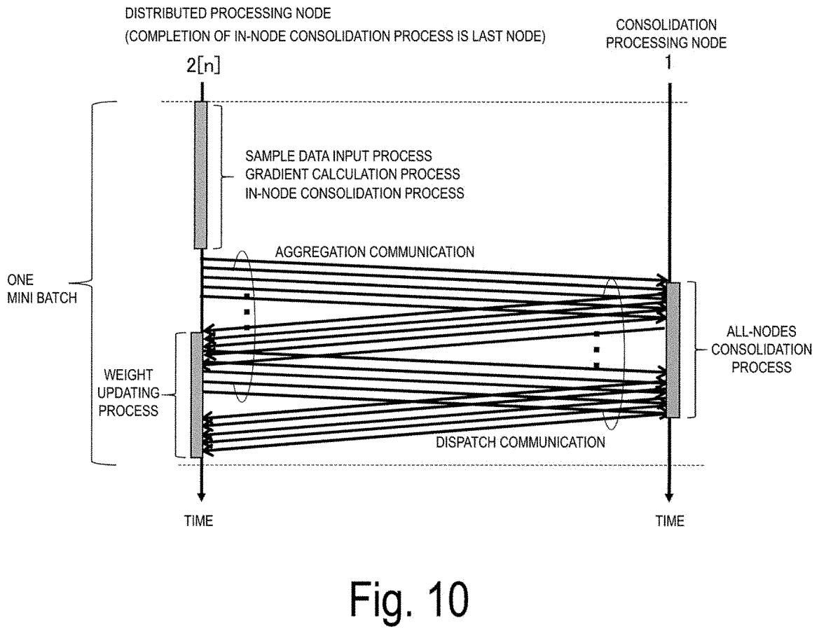

FIG. 10 shows a sequence of processing of the consolidation processing node 1 and the distributed processing nodes 2 [n]. As described above, each of the distributed processing nodes 2 [n] (n=1, . . . , and N) packetizes M pieces of distributed data D [m, n] (m=1, . . . , and M) as packets in the order of numbers m of weights w [m] and transmits the packets to the consolidation processing node 1, and the consolidation processing node 1 performs an aggregation communication process of acquiring M pieces of distributed data D [m, n] (m=1, . . . , and M) in the order of numbers m.

Further, the consolidation processing node 1 performs an all-nodes consolidation process of generating consolidated data R [m] (m=1, . . . , and M) in the order of numbers m on the basis of the M pieces of distributed data D [m, n] (m=1, . . . , and M) acquired in the order of numbers m of weights w [m].

Further, the consolidation processing node 1 packetizes the M pieces of consolidated data R [m] (m=1, . . . , and M) as packets generated in the order of numbers m of weights w [m] and transmits the packets to each of the distributed processing nodes 2 [n] (n=1, . . . , and N), and each of the distributed processing nodes 2 [n] (n=1, . . . , and N) performs a dispatch communication process of acquiring M pieces of consolidated data R [m] (m=1, . . . , and M) in the order of numbers m.

Further, each of the distributed processing nodes 2 [n] (n=1, . . . , and N) performs a weight updating process of updating M weights w [m] in the order of numbers m on the basis of M pieces of consolidated data R [m] (m=1, . . . , and M) acquired in the order of numbers m.

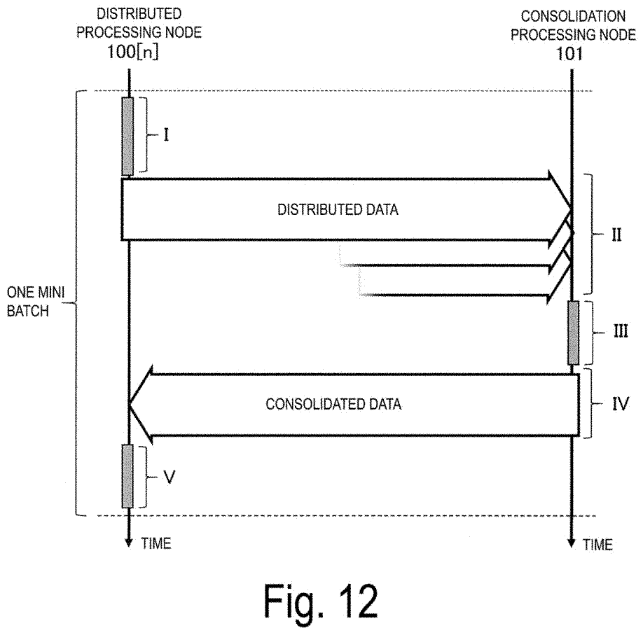

In the present example, an aggregation communication process, an all-nodes consolidation process, a dispatch communication process, and a weight updating process can be performed in parallel at substantially the same time (in a pipelined manner), and a processing time can be drastically reduced as compared to a sequence (FIG. 12) in the related art in which the next process cannot be started until communications and processes are terminated.

In other words, when the transmission unit 23 of each of the distributed processing nodes 2 [n] (n=1, . . . , and N) and the consolidation processing node 1 perform the aggregation communication process described in FIGS. 4 and 5 for distributed data D [m, n] of some weights w [m] among M weights w [m], an all-nodes consolidation process, a dispatch communication process, and a weight updating process are performed as follows.

The consolidation processing node 1 performs the all-nodes consolidation process described in FIG. 6 for the acquired distributed data D [m, n] of weights w [m] having smaller numbers m than those of weights w [m] for which an aggregation communication process is being performed.

The consolidation processing node 1 and the reception unit 24 of each of the distributed processing nodes 2 [n] (n=1, . . . , and N) perform the dispatch communication process described in FIGS. 7 and 8 for consolidated data R [m] of weights W [m] for which a consolidation process has been performed and which have smaller numbers m than those of weights w [m] for which an all-nodes consolidation process is being performed.

The weight updating processing unit 25 of each of the distributed processing nodes 2 [n] (n=1, . . . , and N) perform the weight updating process described in FIG. 9 on the basis of the acquired consolidated data R [m] of weights w [m] having smaller numbers m than those of weights w [m] for which a dispatch communication process is being performed.

Thus, for example, in a case where a time T is required for each of an aggregation communication process, an all-nodes consolidation process, a dispatch communication process, and a weight updating process, a time of 4T is required for the termination of all of these processes in the related art, but a time of T+α is required in the present example. Here, the α is a delay time from a point in time when any distributed processing node 2 [n] transmits any distributed data D [m, n] to the consolidation processing node 1 to when the updating of a weight w [m] is completed. In the present example, processes are performed in a pipelined manner in units of numbers m of weights w [m], and thus a time α is a sufficiently short period of time as compared to T. Thus, in the present example, a time required for an aggregation communication process, an all-nodes consolidation process, a dispatch communication process, and a weight updating process can be shortened to approximately ¼ as compared to the related art.

### Second Example

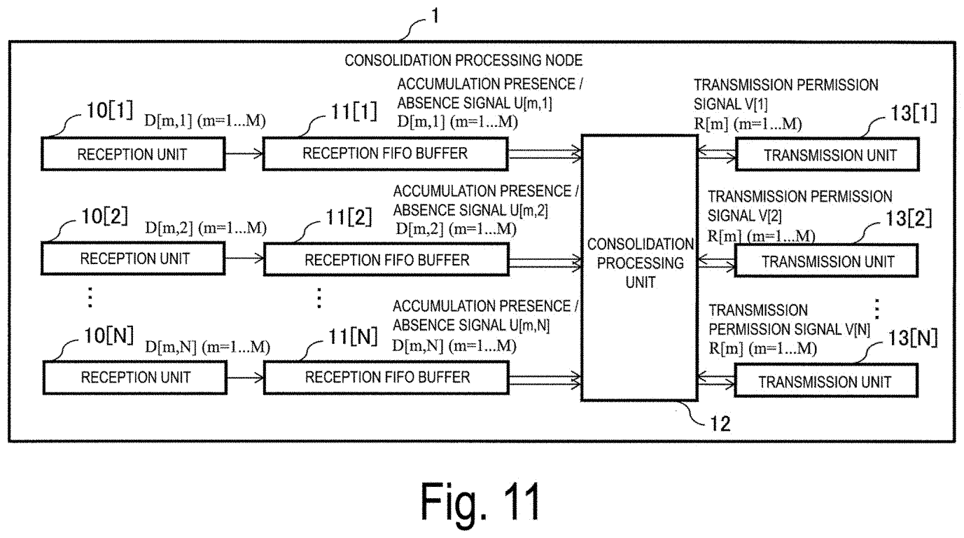

Next, a second example of the present invention will be described. In the present example, a configuration example of the consolidation processing node 1, which is a component of the distributed processing system for deep learning in the first example, is described. FIG. 11 is a block diagram showing a configuration example of the consolidation processing node 1.

The consolidation processing node 1 includes reception units 10 [n] (n=1, . . . , and N), reception First In, First Out (FIFO) buffers 11 [n], a consolidation processing unit 12, and transmission units 13 [n].

As described in the first example, the consolidation processing node 1 receives M pieces of distributed data D [m, n] (m=1, . . . , and M) as Pg aggregation communication packets SP [p, n] (p=1, . . . , and Pg) divided by Lg pieces of consolidated data from each of the distributed processing nodes 2 [n] (n=1, . . . , and N) in an aggregation communication process. Lg pieces of distributed data D [i, n] (i=Lg×(p−1)+l, l=1, . . . , and Lg) are stored in the aggregation communication packets SP [p, n] (p=1, . . . , and Pg).

In addition, the consolidation processing node 1 divides M pieces of consolidated data R [m] (m=1, . . . , and M) to each of the distributed processing nodes 2 [n] (n=1, . . . , and N) by Ls pieces of consolidated data to PS aggregation communication packets DP [p, n] (p=1, . . . , and Ps) and transmits the Ps aggregation communication packets DP [p, n] (p=1, . . . , and Ps) in a dispatch communication process.

As shown in FIG. 11, the consolidation processing node 1 includes the reception unit 10 [n] for receiving aggregation communication packets SP [p, n] from each of the distributed processing nodes 2 [n] (n=1, . . . , and N) for each distributed processing node 2 [n].

Each of the reception unit 10 [n] perform the aggregation communication process described in FIG. 5. Specifically, each of the reception units 10 [n] receives aggregation communication packets SP [p, n] transmitted by the corresponding distributed processing nodes 2 [n], acquires Lg pieces of distributed data D [i, n] (i=Lg×(p−1)+l, l=1, . . . , and Lg) stored in the order of numbers m of weights w [m] in the aggregation communication packet SP [p, n] in the order of numbers i (i is a portion of a number m of a weight w [m]), and transmits the acquired data to a reception FIFO buffer 11 [n] at the subsequent stage.

As shown in FIG. 11, the consolidation processing node 1 includes the reception FIFO buffer 11 [n] for each reception unit 10 [n] (for each distributed processing node 2 [n]). Further, the consolidation processing node 1 includes the consolidation processing unit 12 that reads distributed data D [m, n] of a number m (m=1, . . . , and M) stored in each of the reception FIFO buffers 11 [n] (n=1, . . . , and N) from each of the reception FIFO buffers 11 [n] and consolidates the read data. The reception FIFO buffer 11 [n] and the consolidation processing unit 12 perform the all-nodes consolidation process described in FIG. 6.

Specifically, the reception FIFO buffer 11 [n] accumulates Lg pieces of distributed data D [i, n] (i=Lg×(p−1)+l, l=1, . . . , and Lg) transmitted from the corresponding reception unit 10 [n] in the order of numbers i (i is a portion of a number m). The accumulation is started from a state where each of the reception FIFO buffers 11 [n] is empty. The reception of the aggregation communication packet SP [p, n] and the accumulation of the distributed data D [i, n] are performed Pg times, so that M pieces of distributed data D [m, n] are accumulated in each of the reception FIFO buffers 11 [n].

Thus, in a case where the same number of pieces of distributed data among the pieces of distributed data accumulated in each of each of the reception FIFO buffers 11 [n] is read, the pieces of distributed data D [m, n] read from each of the reception FIFO buffers 11 [n] are arranged in the order of m=1, . . . , and M.

Each of the reception FIFO buffers 11 [n] (n=1, . . . , and N) outputs an accumulation presence/absence signal U [n] indicating whether or not distributed data has been accumulated to the consolidation processing unit 12.

In a case where all of the accumulation presence/absence signals U [n] (n=1, . . . , and N) indicate that distributed data has been accumulated, the consolidation processing unit 12 reads the distributed data one by one from each of the reception FIFO buffers 11 [n]. Note that each of the reception FIFO buffers 11 [n] accumulates distributed data in the order of numbers m, and the consolidation processing unit 12 reads the same number of pieces of distributed data from each of the reception FIFO buffers 11 [n]. For this reason, the numbers m of the pieces of distributed data read from each of the respective reception FIFO buffers 11 [n] has the same value between the reception FIFO buffers 11 [n]. Thus, the accumulation presence/absence signal U [n] does not need to specify the number m of distributed data and only needs to indicate whether or not distributed data to be read next has been accumulated in each of the reception FIFO buffers 11 [n].

As will be described later, the consolidation processing unit 12 stores consolidated data R [m] generated on the basis of distributed data D [m, n] that has been read in the dispatch communication packet and transmits the stored data from each of the transmission units 13 [n](n=1, . . . , and N). However, in a state where a dispatch communication packet is not transmitted (for example, while another dispatch communication packet is transmitted), the consolidation processing unit 12 holds the reading of the next distributed data D [m, n] until a dispatch communication packet can be transmitted.

For this reason, each of the transmission units 13 [n] (n=1, . . . , and N) outputs a transmission permission signal V [n] indicating that a dispatch communication packet can be transmitted to the consolidation processing unit 12 when the dispatch communication packet can be transmitted.

The consolidation processing unit 12 receives accumulation presence/absence signals U [n] from each of the reception FIFO buffers 11 [n] (n=1, . . . , and N) and transmission permission signals V [n] (n=1, . . . , and N) from each of the transmission units 13 [n] (n=1, . . . , and N) and determines whether or not to read distributed data from each of the reception FIFO buffers 11 [n].

Specifically, the consolidation processing unit 12 reads distributed data D [m, n] from each of the reception FIFO buffers 11 [n] when the accumulation presence/absence signal U [n] indicates that distributed data D [m, n] to be read next has been accumulated and the transmission permission signal V [n] indicates that a dispatch communication packet including consolidated data R [m] generated from the read distributed data D [m, n] can be transmitted.

Further, the consolidation processing unit 12 generates pieces of consolidated data R [m] in the order of numbers m on the basis of pieces of distributed data D [m, n] (n=1, . . . , and N) read in the order of numbers m from each of the respective reception FIFO buffers 11 [n] and transmits the generated consolidated data R [m] to the transmission unit 13 [n] at the subsequent stage in the order of numbers m. Here, the same consolidated data is transmitted to each of the transmission units 13 [n]. A calculation equation for the consolidated data R [m] is as shown in Equation (2).

The transmission unit 13 [n] for transmitting a dispatch communication packet to each of the distributed processing nodes 2 [n] (n=1, . . . , and N) is provided for each distributed processing node 2 [n]. The transmission unit 13 [n] performs the dispatch communication process described in FIG. 7.

Each of the transmission units 13 [n] divides pieces of consolidated data R [m] (m=1, . . . , and M) transmitted in the order of numbers m from the consolidation processing unit 12 into Ps dispatch communication packets by Ls dispatch communication packets and transmits distributed data. That is, Ls pieces of consolidated data R [j] (=Ls×(p−1)+k, k=1, . . . , and Ls) are stored in the p-th dispatch communication packet DP [p, n] (p=1, . . . , and Ps) to be transmitted toward the distributed processing node 2 [n]. As described above, each of the transmission units 13 [n] outputs a transmission permission signal V [n] to the consolidation processing unit 12 when the dispatch communication packet DP [p, n] can be transmitted.

As described in the first example, each of the transmission units 13 [n] stores (M−Ls×(Ps−1)) pieces of consolidated data R [j]=Ls×(Ps−1)+0; 0=1, . . . , and M−Ls×(Ps−1)) in the Ps-th dispatch communication packet DP [Ps, n] in a condition where M cannot be divided by Ls. In addition, each of the transmission units 13 [n] may add numerical values of {Ls−(M−Ls×(Ps−1))} dummies after (M−Ls×(Ps−1)) pieces of consolidated data R [j] for the Ps-th dispatch communication packet DP [Ps, n], and all of the dispatch communication packets may equally store Ls pieces of data.

As described above, the reception units 10 [n] (n=1, . . . , and N) extract pieces of distributed data D [m, n] in the order of numbers m (m=1, . . . , and M) of weights w [m] from the aggregation communication packet received from the distributed processing node 2 [n] and store the extracted data in each of the reception FIFO buffer 11 [n] for each distributed processing node in the order of numbers m.

The consolidation processing unit 12 reads the distributed data D [m, n] in the order of numbers m from each of the reception FIFO buffers 11[n] to generate consolidated data R [m] on the basis of the read distributed data D [m, n]. Further, each of the transmission units 13 [n] stores the generated consolidated data R [m] in the dispatch communication packet in the order of numbers m and transmits the dispatch communication packet to each of the distributed processing nodes 2 [n].

In the related art described in FIG. 12, the consolidation processing node 101 receives all of the pieces of distributed data D [m, n] (m=1, . . . , and M) from the distributed processing node 100 [n] and then consolidates the distributed data D [m, n] to generate all pieces of consolidated data R [m] (m=1, . . . , and M), and then returns the consolidated data R [m] to the distributed processing node 100 [n].

On the other hand, in the present example, an aggregation communication process, an all-nodes consolidation process, and a dispatch communication process in the consolidation processing node 1 can be performed in a pipelined manner for different numbers m. For this reason, a time from when pieces of distributed data D [m, n] are received from the each of distributed processing nodes 2 [n] to when pieces of consolidated data R [m] obtained by consolidating the distributed data D [m, n] for all nodes are returned to each of the distributed processing nodes 2 [n] can be drastically reduced as compared to the related art.

For example, assuming that a time required for processes related to a number m is t, a time from when pieces of distributed data D [m, n] are received from each of the distributed processing nodes 2 [n] to when pieces of consolidated data R [m] obtained by consolidating the distributed data D [m, n] for all of the distributed processing nodes 2 [n] are returned to each of the distributed processing nodes 2 [n] is 4t (the number of pipeline stages=4) in embodiments of the present invention.

On the other hand, in the related art, a time is required for processes by m times, and thus a time from when pieces of distributed data D [m, n] are received from each of the distributed processing nodes 100 [n] to when pieces of consolidated data R [m] are returned to each of the distributed processing nodes 100 [n] is 4t×M. Thus, in the present example, a time can be shortened to 1/M (m is the number of weights w [m], which may be a value of approximately 100,000,000).

The other components of the distributed processing system are the same as those described in the first example, and thus description thereof will be omitted in the present example.

Each of the consolidation processing node 1 and the distributed processing node 2 [n] described in the first and second examples can be realized by a computer including a central processing unit (CPU), a storage device, and an interface, and programs for controlling these hardware resources. The CPU of each of the consolidation processing node 1 and the distributed processing node 2 [n] executes the processes described in the first and second examples in accordance with programs stored in each of the storage devices.

### INDUSTRIAL APPLICABILITY

The present invention can be applied to techniques for performing machine learning of a neural network.

### REFERENCE SIGNS LIST

1 Consolidation processing node
2 Distributed processing node
10 Reception unit
11 Reception FIFO buffer
12 Consolidation processing unit
13 Transmission unit
20 Sample input unit
21 Gradient calculation processing unit
22 In-node consolidation processing unit
23 Transmission unit
24 Reception unit
25 Weight updating processing unit
26 Neural network

1.-4. (canceled)

5. A distributed processing system comprising:
a consolidation processor; and
N distributed processors, wherein N is an integer equal to or greater than 2, and wherein each of the N distributed processors is configured to:
packetize distributed data D [m, n] as first packets for each of M weights w [m] of a neural network to transmit the first packets to the consolidation processor, the distributed data D[m, n] is packetized in an order of numbers m, n=1, . . . , and N, m=1, . . . , and M, and M is an integer equal to or greater than 2; and
receive second packets, from the consolidation processor, to acquire consolidated data R [m] to update the M weights w [m] of the neural network according to the consolidated data R [m], the consolidated data R[m] is received in the order of the numbers m; and
wherein the consolidation processor is configured to:
receive the first packets transmitted from each of the distributed processors to acquire the distributed data D [m, n];
generate the consolidated data R [m] by consolidating the distributed data D [m, n] of the distributed processors for each of the M weights w [m]; and
packetize the consolidated data R [m] as the second packets to transmit the second packets to each of the N distributed processors, wherein the consolidated data R [m] is packetized in the order of the numbers m.

6. The distributed processing system according to claim 5, wherein each of the N distributed processors includes:
a transmitter configured to packetize the distributed data D [m, n] as the first packets in the order of the numbers m to transmit the first packets to the consolidation processor;
a receiver configured to receive the second packets from the consolidation processor to acquire the consolidated data R [m] in the order of the numbers m; and
a weight updating processor configured to update the M weights w [m] of the neural network according to the consolidated data R [m].

7. The distributed processing system according to claim 5, wherein the consolidation processor includes:
a receiver configured to receive the first packets transmitted from each of the N distributed processors to acquire the distributed data D [m, n] in the order of the numbers m;
a consolidation processor configured to generate the consolidated data R [m] by consolidating the distributed data D [m, n] of the N distributed processors for each of the M weights w [m]; and
a transmitter configured to packetize the consolidated data R [m] as the second packets in the order of the numbers m to transmit the second packets to each of the N distributed processors.

8. The distributed processing system according to claim 5, wherein each of the N distributed processors further includes:
a gradient calculation processor configured to calculate a respective gradient of a loss function of the neural network for each piece of sample data with respect to each of the M weights w [m] when sample data for learning the neural network is input; and
an in-node consolidation processor configured to generate and store the distributed data D [m, n], wherein the distributed data D[m,n] is numerical values obtained by consolidating the respective gradient for each piece of the sample data with respect to each of the M weights w [m].

9. A method comprising:
packetizing, by each of N distributed processors, distributed data D [m, n] as first packets for each of M weights w [m] of a neural network to transmit the first packets to a consolidation processor, the distributed data D[m, n] is packetized in an order of numbers m, N is an integer equal to or greater than 2, n=1, . . . , and N, m=1, . . . , and M, and M is an integer equal to or greater than 2; and
receiving, by each of the N distributed processors from the consolidation processor, second packets, to acquire consolidated data R [m] to update the M weights w [m] of the neural network according to the consolidated data R [m], the consolidated data R[m] is received in the order of the numbers m.

10. The method according to claim 9 further comprising:
receiving, by the consolidation processor, the first packets transmitted from each of the N distributed processors to acquire the distributed data D [m, n];
generating, by the consolidation processor, the consolidated data R [m] by consolidating the distributed data D [m, n] of the distributed processors for each of the M weights w [m]; and
packetizing, by the consolidation processor, the consolidated data R [m] as the second packets to transmit the second packets to each of the N distributed processors, wherein the consolidated data R [m] is packetized in the order of the numbers m.

11. The method of claim 9, further comprising:
calculating a respective gradient of a loss function of the neural network for each piece of sample data with respect to each of the M weights w [m] when sample data for learning the neural network is input; and
generating and storing the distributed data D [m, n], wherein the distributed data D[m,n] is numerical values obtained by consolidating the respective gradient for each piece of the sample data with respect to each of the M weights w [m].
